(19) United States
(12) Patent Application Publication
(10) Pub. No.: US 2012/0032750 A1
(43) Pub. Date: Feb. 9, 2012

(54) ANGLED JUNCTION BETWEEN A MICROSTRIP LINE AND A RECTANGULAR WAVEGUIDE

(75) Inventor: Peter Feil, Ulm (DE)

(73) Assignee: UNIVERSITAT ULM, Ulm (DE)

(21) Appl. No.: 12/995,744

(22) PCT Filed: Jun. 3, 2009
(86) PCT No.: PCT/EP2009/003971

§ 371 Date: May 11, 2011

(30) Foreign Application Priority Data
Jun. 3, 2008 (DE) 10 2008 026 579.9

(51) Int. Cl. H01P 5/107

(52) U.S. Cl. 333/26; 29/825

(57) ABSTRACT

The present invention relates, in the field of high frequency technology, to a transition element for transferring an electromagnetic wave in a strip transmission line into a waveguide. A waveguide with a first opening is thereby applied on a substrate, on which in addition strip transmission line and strip transmission line stub are situated, and contacted and/or coupled to a strip transmission line or to a strip transmission line and a strip transmission line stub. In the first opening, an electrical field then forms a wave in the strip transmission line.

The invention relates, in the field of high frequency technology, to a transition element for converting a strip transmission line into a waveguide.

Transition elements from planar circuit technology to a waveguide have been widespread for some years and are used typically in radar and communications technology, in the microwave and millimetre wave range. They serve for the purpose of connecting planar integratable components, such as for example MMICs, to low-loss waveguides and/or antennae fed by waveguides.

Transition elements are known from the state of the art, which elements normally have a specially configured emitter element (English patch) which is situated on a substrate layer which is approx. 100 μm thick.

Through-contactings in the substrate layer form an extension of the waveguide which is disposed on a substrate. Below the substrate layer in the region of the borings, a cap made of a conductive material forms a “cavity” or “backshort”. The emitter element protrudes into the waveguide such that the spacing between emitter element and cap is λ/4 or an odd integer multiple thereof. Since hence an open circuit is produced in the plane of the emitter element in the region of the cavity (backshort), the electromagnetic wave in a strip transmission line can be fed into the waveguide.

The production of conventional transition elements from planar circuit technology to a waveguide has proved to be problematic because of the through-contactings. In order to through-contact conventional carrier materials, the borings must be metallised. The metallisation of Teflon-based substrates has however to date required complex production methods and is not available for simple economical printed board manufacture. In addition, conventional transition elements have to date required a two-layer printed circuit board structuring.

Starting from the state of the art, it is therefore the object of the present invention to make available a transition element for transferring an electromagnetic wave in a strip transmission line into a waveguide, the manufacture of which transition element is based on simple production processes.

This object is achieved by the transition element according to claim 1 and also advantageous developments and arrangements thereof according to the dependent claims. Typical uses of the transition element according to the invention are provided in claim 20. The transition element according to the invention is used furthermore in the method for producing microwaves according to claim 21.

According to the invention, the transition element for a transition of a wave from a strip transmission line to a waveguide comprises a planar substrate, at least one strip transmission line and a waveguide. At least one of the strip transmission lines which are situated on a first side of the planar substrate has at least one strip transmission line end. The waveguide forms a circumferential lip around its first opening. The transition element according to the invention is constructed such that the waveguide is placed in the region of a strip transmission line end with the circumferential lip on the first side of the substrate, the strip transmission line and the waveguide being contacted or coupled electrically to each other at least one point of the lip. It must thereby be ensured that a contacting or electrical coupling between strip transmission line and waveguide can be formed merely in the region of the lip since the strip transmission line is insulated from the waveguide at all remaining places/surfaces. Because of the contacting or coupling of strip transmission line end and waveguide, an electrical field is produced in the opening or in the slot of the waveguide formed by the opening. This electrical field excites a wave in the waveguide which is guided with low loss through the waveguide.

According to the invention, a strip transmission line stub is disposed on the first side of the planar substrate, at a spacing from the strip transmission line end due to a short interruption. This strip transmission line stub is likewise contacted or coupled electrically to the waveguide via the lip and represents a virtual or real short circuit. Advantageously, the contact- or coupling point between strip transmission line stub and lip is disposed such that it is situated opposite the contact- or coupling point between strip transmission line and waveguide and/or such that the stretch between the two coupling points is equally wide when rounding the lip, irrespective of the circumferential direction. The interruption between strip transmission line end and strip transmission line stub corresponds to the dimensions of the waveguide cross-section, i.e. to the diameter or a side length of the cross-section. According to the width of the lip, the interruption can have a length of twice the lip width plus the dimension of the opening.

The strip transmission line stub preferably has a length of the order of magnitude of λ/4, preferably λ/4±30%, in particular λ/4±15%, or an odd integer multiple thereof. A strip transmission line with such a length with an open end acts like a virtual short circuit. The value A in this example is defined as the wavelength of an electromagnetic wave which a corresponding generator feeds or fed into the strip transmission line. The length of the strip transmission line stub depends inter alia also upon the width of the lip of the waveguide.

Alternatively, a real short circuit can be formed by the strip transmission line stub, said short circuit being earthed below the lip, in the immediate vicinity of the lip or at a spacing of λ/2±30%, in particular λ/2±15%, or an integer multiple thereof, by means of a through-contacting. As a function of whether of concern are a two-layer circuit board structuring, a single-layer structuring on a solid metallic carrier or a carrier plate with coplanar strip transmission line technology, the contacting of the strip transmission line stub is effected in different ways. In the case of two-layer or single-layer printed circuit board technology, the carrier material being situated in single-layer construction on a solid metallic carrier, the contacting between strip transmission line stub and earth is effected via a through-contacting. In the case of construction with coplanar technology, direct contacting between earth and strip transmission line stub suffices in contrast.

The waveguide of the transition element according to the invention can be applied without difficulty on differently designed printed circuit boards. The only difference resides in the fact that, according to printed circuit board technology, a second side of the substrate is metallised completely or partially and/or the first side of the substrate in regions. It must be ensured that the metallic layer on the first side of the substrate is insulated from the strip transmission lines on the first side of the substrate.

The metallisation on the second side of the substrate can have different thicknesses in the range of 5 μm and 10 mm. If a two-layer printed circuit board structuring is involved, the metallic layer has a thickness of 17 μm to 50 μm. A single-layer printed circuit board structuring concerns, in the case of the metallic layer, a solid metallic carrier plate. This carrier plate has a thickness in the range of 10 μm to 10 mm, in particular in the range of 500 μm and 1 mm.

There are possible as waveguides of the transition element according to the invention, waveguides with different cross-sections. Preferably, the waveguide is configured as a rectangular waveguide, round waveguide or waveguide with an elliptical cross-section.

Irrespective of the cross-section of the respective waveguide which is used, the first opening or the lip of the first waveguide has a circumference of the order of magnitude of λ, in particular of λ±30%, in particular λ±15%, or an integer multiple thereof. It is hence ensured that the wave in the slot or in the opening of the waveguide forms an electrical field. This is possible since a slot of length λ/2 or an integer multiple thereof forms a resonator.

If the waveguide of the transition element according to the invention is a rectangular waveguide, then the short side of the first opening can have a length in the range of λ/20 and λ/5, whilst the long side has a length of the order of magnitude of λ/2, in particular of λ/2±30%, in particular λ/2±15%, or an integer multiple thereof. When using a round waveguide, the radius should be chosen such that r=λ/(2π) applies.

The lengths of the short and long side of the waveguide opening can however be varied such that twice the sum of length and width produces a value of the order of magnitude of λ, in particular of λ±30%, in particular λ±15%, or an integer multiple thereof. In order however to achieve good coupling, the length of the short side should preferably be negligibly small and the contacting- or coupling points on the lip should be situated on the long side of the lip.

According to the printed circuit board technology which is used, the strip transmission lines are microstrip transmission lines and/or coplanar transmission lines. For waves in the microwave range, the strip transmission lines have a width in the range of 100 λm to 800 λm. At lower frequencies, the width can be in the range of a few millimetres, preferably less than or equal to 4 mm.

The substrate, on the first side of which the strip transmission lines are disposed, advantageously comprises a polymeric material, in particular polytetrafluoroethylene, or consists of such a material. There are also included therein materials based on Teflon. However, also ceramic materials, glasses or composite materials can serve as substrate material.

The lip of the waveguide has a width of less than or equal to the strip transmission line width plus 50%, in particular 30%. The width of the lip is thereby defined as the width transversely relative to the circumferential direction of the lip in the plane of the coupling point parallel to the substrate.

The waveguide in the transition element according to the invention is advantageously disposed on the first side of the substrate such that the strip transmission line end is situated under the lip in the centre between the adjacent waveguide inner wall and the outside of the lip. This means at the same time that the strip transmission line end is disposed in the centre of the lip width. Also the strip transmission line stub is disposed such that its one end is situated below the lip at half the width of the lip.

In order to be able to dispose the transition element according to the invention easily on the first side of the substrate, it is advantageous to choose the wall of the waveguide to be as thick as possible in order to obtain as large a surface of the waveguide as possible on the side of the first opening. Advantageously, the wall thickness of the waveguide is greater than or equal to the strip transmission line width, preferably greater than or equal to 5 mm, particularly preferred greater than or equal to 20 mm, particularly preferred at a value of the order of magnitude of a standard waveguide flange corresponding to the respective wavelength. The waveguide lip which, as mentioned above, has approximately a width of less than or equal to the strip transmission line width, is then formed by a groove extending around the first opening in the end-side of the waveguide which has the first opening. The groove serves, on the one hand, for shaping the lip and, on the other hand, for electrical decoupling of the planar supported structure from the actual transition. In particular, the so-called parallel plate waves between the planar structure and the rear-side metallisation is as a result prevented from being excited. The surface of the lip, for reasons of mechanical stability, is situated completely on the substrate. The mentioned end-side of the waveguide can have at least one further groove in which the strip transmission line is guided. The groove thereby serves for insulation of the strip transmission line relative to the waveguide. The groove surrounding the lip has for example a width in the range of λ/20 and λ/5 and a depth of the order of magnitude of λ/4, in particular of λ/4±30%, in particular of λ/4±15%, or a multiple thereof. This can be generalised with the statement that the width and twice the depth of the groove hence produces a value of the order of magnitude λ/2, in particular λ/2±30%, in particular λ/2±15%, or an odd integer multiple thereof. Hence width and depth of the groove are directly correlated to each other and can correspondingly be varied. Preferably, the waveguide of the transition element according to the invention does not correspond to the standard dimensions of conventional waveguides. The waveguide opens therefore by its second opening orientated away from the substrate into an adaptor element for widening or reducing the circumference of the waveguide. Such an adaptor element can also serve for changing the waveguide cross-section. With the help of this adaptor element, the wave excited in the waveguide can be transformed to an additional waveguide with standard dimensions. Normally, the adaptor element is a λ/4 transformer. A λ/4 transformer is essentially a waveguide part with a length of λ/4, the cross-section being situated between the dimensions of the cross-section of a first waveguide and those of a second waveguide. The waveguide part of the λ/4 transformer can be produced by any cross-section—rectangular, round, oval. As adaptor element, also a so-called taper, which enables continuous adaptation of the cross-section of the waveguide to the cross-section of the additional waveguide, can be used. Such a taper is however difficult to produce by milling technology.

The waveguide of the transition element according to the invention and the adaptor element are advantageously configured from one piece. Advantageously, the waveguide of the transition element according to the invention, the adaptor element and also an additional waveguide can be configured in one piece. The waveguide and the adaptor element normally consist of a conducting material or comprise such. Advantageously, the waveguide and/or the adaptor element can be produced by injection moulding technology, the surfaces forming the waveguide and/or the adaptor element being metallised. The production of waveguide and adaptor element by injection moulding technology would substantially reduce the production costs of the transition element according to the invention.

Furthermore, the possibility exists of providing the substrate with borings adjacent to the lip or in the region below the lip or groove, along the lip or groove, the side walls of which borings are metallised and the consequently produced through-contactings being connected electrically to the metallic layer on the second side of the substrate. The through-contactings are only of advantage when no overcouplings to adjacent circuit parts should result. They are not a characteristic feature of the invention.

The transition element according to the invention can be contained for example in a microwave emitter. A generator thereby produces a radiation with the wavelength λ which is fed into the strip transmission line of the transition element and from there is transferred into the waveguide.

Transition elements according to the invention are used in particular in radar and communications technology in a wavelength of microwaves up to millimetre waves (10 to 90 GHz). As an example of the use of a transition element according to the invention in radar technology, motor vehicle radar may be mentioned on the one hand for distance measurement, on the other hand, radar in helicopters and/or aircraft for height measurement but also radar in airports or runway monitoring.

Furthermore, radar technology is used in level measurements, in particular of reactive materials. In the field of communications technology, use in the frequency range between 70 and 90 Ghz, as was provided already, would be advantageous since very high data rates would be possible in this frequency range.

For production of microwave radiation, firstly a wave in the micro- or millimetre wave range is produced by a corresponding generator and fed into the strip transmission line of the transition element according to the invention. In the opening of the waveguide, the so-called slot, an electrical field is produced by the supplied radiation and in turn excites micro- or millimetre waves in the waveguide. Hence the wave is transferred from the strip transmission line into the waveguide.

A few examples of transition elements and arrangements according to the invention are provided subsequently. There are shown

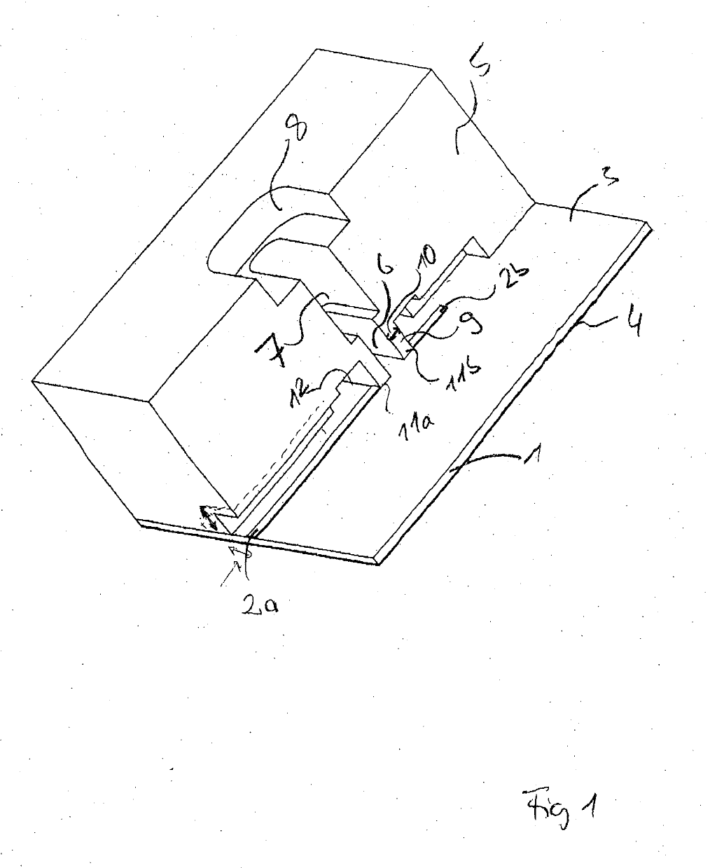

FIG. 1 a cross-section through a transition element according to the invention split open along the strip transmission line;

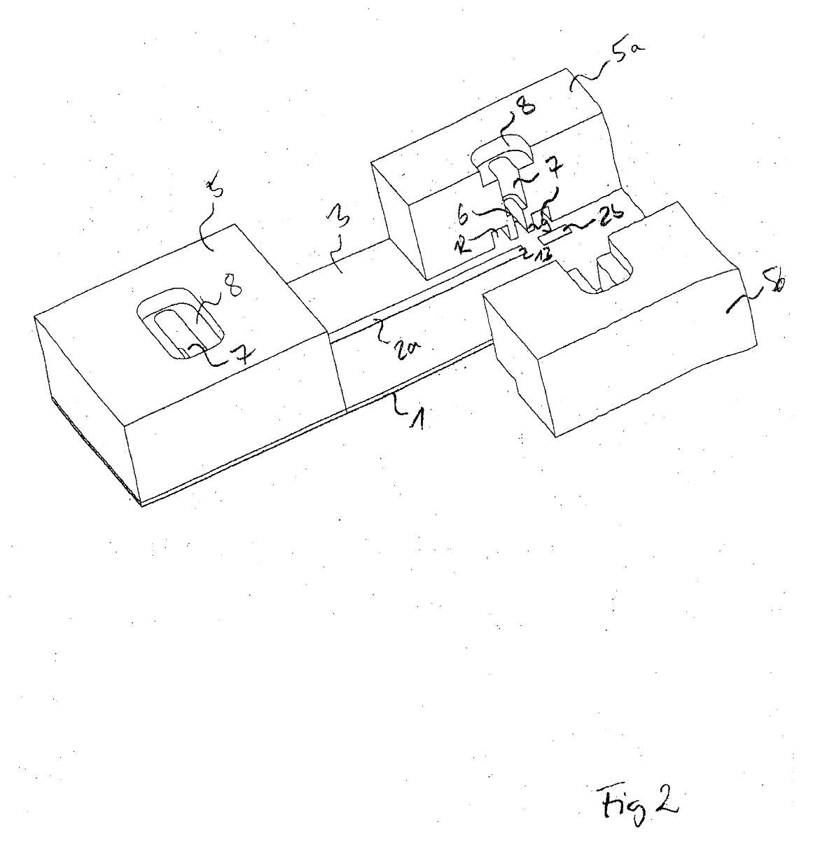

FIG. 2 the three-dimensional view of a transition element according to the invention and also of a transition element according to the invention split open along the strip transmission line;

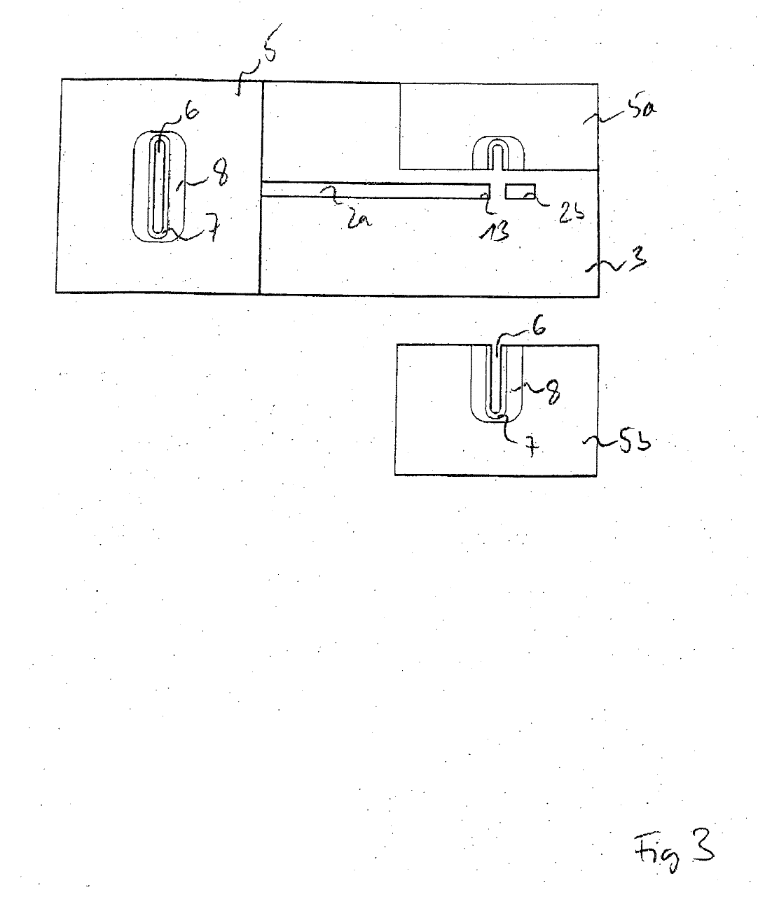

FIG. 3 the plan view on a transition element according to the invention and also of a transition element according to the invention split open along the strip transmission line;

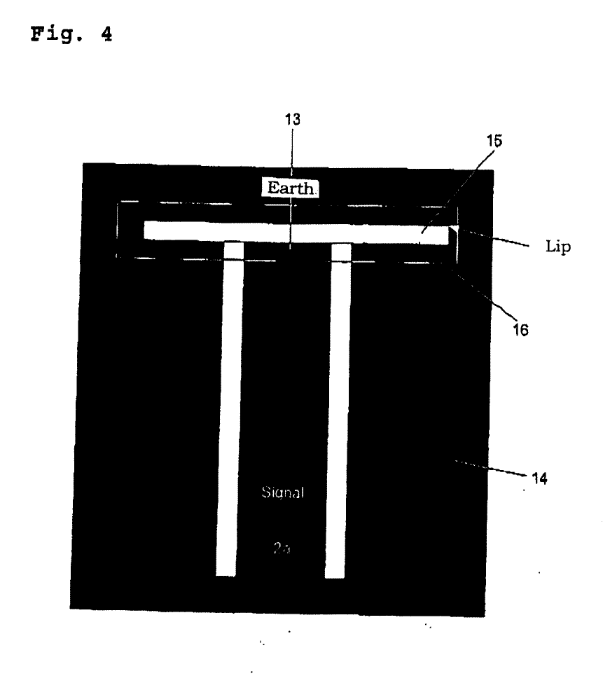

FIG. 4 plan view on a transition element according to the invention, the circuit board technology being based on coplanar technology; and

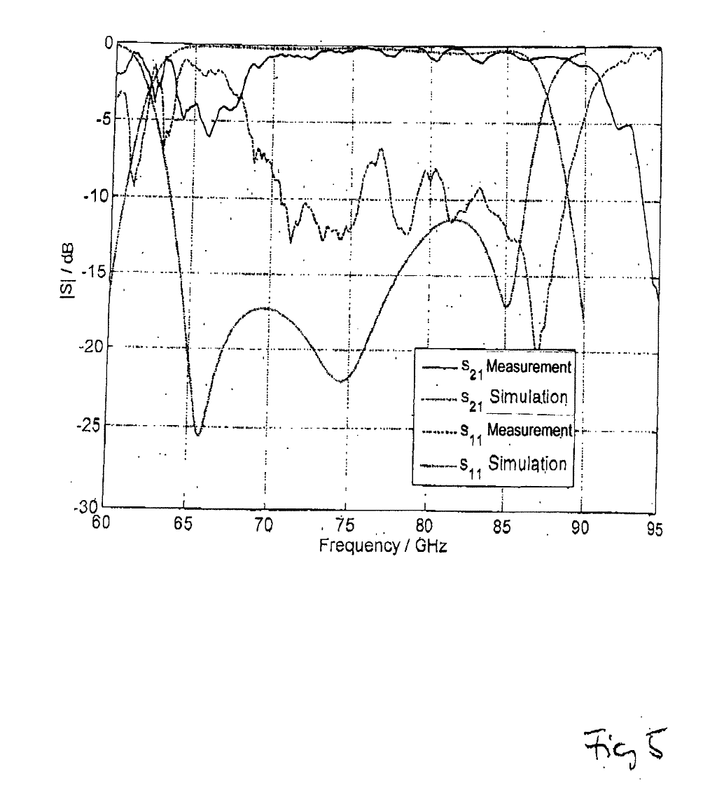

FIG. 5 the result of measurements of the transmission and also of the reflection.

FIG. 1 shows a substrate 1 having a first surface 3 and a second surface 4, a strip transmission line 2a and a strip transmission line stub 2b being disposed on the first surface 3. On the first side 3 of the substrate 1 an element 5 is disposed, which element has a waveguide 6, a λ/4 transformer 7 and an additional waveguide 8 with standard dimensions. The element 5 is placed on the first side 3 of the substrate 1 such that the lip 9 with a lip width 10 of the order of magnitude of the strip transmission line width sits directly on the first side 3 of the substrate 1. The lip 9 is surrounded by a circumferential groove 12. The strip transmission line 2a and the strip transmission line stub 2b is contacted or coupled electrically to the lip 9 of the waveguide 6 at both contact- or coupling points 11a and 11b.

The reference numbers used previously are used for identical or similar elements in the following Figures.

A similar construction to FIG. 1 is represented in FIG. 2. On the first side 3 of the substrate 1, there are situated above the strip transmission line 2a, two elements 5 which have respectively a waveguide 6, a λ/4 transformer 7 and an additional waveguide 8 with standard dimensions, for example a WR12 waveguide with the dimensions 3.1 mm×1.55 mm. One of the elements 5 is divided into two parts 5a and 5b, the part 5b being displaced such that the strip transmission line end 13 and also the strip transmission line stub 2a appear. The lip 9 and the groove 12 which surrounds the lip 9 are clearly detectable again.

FIG. 3 shows the plan view on the construction in FIG. 2. The first side 3 of the substrate 1 on which the strip transmission line 2a with the strip transmission line end 13 and also the strip transmission line stub 2b are disposed is detected. Furthermore, the element 5 and the partial element 5a are situated on the first side 3 of the substrate 1. The partial element 5b is displaced from the substrate 1. The element 5 clearly shows the different cross-sections of the waveguide 6, of the λ/4 transformer 7 and also of the additional waveguide 8 with standard deviations.

FIG. 4 shows the first side 3 of the substrate 1 with the strip transmission line 2a of a transition element according to the invention, coplanar technology being chosen as printed circuit board technology. It is detected that the strip transmission line end 13 of the coplanar transmission line 2a is situated in the region of an edge 16 embossed on the first side 3 of the substrate 1. The edge 16 indicates where the lip 9 of the waveguide 6 is placed subsequently. Due to the edge 16, an opening 15 in which an electrical field is produced after placing on of the waveguide 6 is configured. At a specific spacing relative to the coplanar transmission line, a metallic layer 14 is applied on the first side 3 of the substrate 1 which represents earth (not shown). The function of the transition according to the invention of strip transmission line to waveguide was established by means of field simulation (CST Microwave Studio) and by measurements on a prototype. The results are shown in FIG. 5. On the one hand, a broadband transmission behaviour (s₂₁) and, on the other hand, a low reflection at the input (s₁₁) can be detected. It is recognised that in particular the transmission behaviour from simulation (continuous line) and measurement (dot-dash line) correspond well. In contrast, the reflection shows relatively great differences above all in the frequency range below 70 GHz. This resides in the fact that the measuring apparatus used is suitable merely for frequencies greater than 75 GHz and fails for frequencies in the range below 70 GHz. The reflection which was determined during the measurement (broken line) is situated substantially higher than that which was simulated by simulation (dotted line). The undulation of the results which was obtained by measurement is accounted for by the measuring method (scaler measurement in the back-to-back arrangement: HL-MSL-HL).

1. A transition element from a strip transmission line to a waveguide having a planar substrate which has a first side including at least one strip transmission line with at least one strip transmission line end, and a waveguide which has a circumferential lip which forms a first opening of the waveguide, wherein the waveguide is oriented in the region of the strip transmission line end with the circumferential lip on the first side of the substrate, the strip transmission line being coupled electrically to the waveguide at least one point of the lip.

2. A transition element according to claim 1 wherein the at least one strip transmission line stub is disposed on the planar substrate at a place of the lip situated opposite the coupling between the waveguide and the strip transmission line, and is coupled to the waveguide, the strip transmission line stub being formed as one of a virtual short circuit and a real short circuit.

3. A transition element according to claim 2 wherein the strip transmission line stub has a length of λ/4±30% or an odd integer multiple thereof or is grounded.

4. A transition element according to claim 1 wherein at least one of the first side of the substrate and a second side of the substrate is metallized in regions.

5. A transition element according to claim 4 wherein the metallization on the second side of the substrate has a thickness between 1 μm and 10 mm.

6. A transition element according to claim 1 wherein the waveguide is one of a rectangular cross-section waveguide, a round circular cross-section waveguide and a waveguide with an elliptical cross-section.

7. A transition element according to claim 1 wherein the circumference of the first opening of the first waveguide has a length of λ±30% or an integer multiple thereof.

8. A transition element according to claim 6 wherein the first opening of the rectangular waveguide has a short side with a length in the range between λ/20 and λ/5 and a long side with a length of λ/2±30% or an integer multiple thereof.

9. A transition element according to claim 1 wherein the strip transmission line comprises at least one of a microstrip transmission line and a coplanar transmission line.

10. A transition element according to claim 1 wherein the substrate on which the strip transmission line is applied comprises at least one of a polymeric material, polytetrafluoroethylene, a ceramic material, a glass and a composite material.

11. A transition element according to claim 1 wherein the lip has a width, transversely relative to the circumferential direction of the lip in the plane of the at least one coupling point parallel to the substrate, less than or equal to the strip transmission line width plus 50%.

12. A transition element according to claim 11 wherein the strip transmission line end is situated in the region of the width of the lip.

13. A transition element according to claim 1 wherein the wall of the waveguide has a thickness greater than or equal to the strip transmission line width, the lip being formed by a groove surrounding the first opening in the end-side of the waveguide which has the first opening.

14. A transition element according to claim 13 wherein the sum of width and twice the depth of the groove assumes a value of λ/2±30% or an integer multiple thereof.

15. A transition element according to claim 1 wherein the waveguide opens on its side orientated away from the substrate into an adapter element for at least one of widening the waveguide, reducing the waveguide and changing the circumference of the waveguide.

16. A transition element according to claim 15 wherein the waveguide and the adapter element are configured in one piece.

17. A transition element according to claim 15 wherein at least one of the waveguide and the adapter element is produced by injection molding technology, the surfaces forming the at least one of the waveguide and the adapter element being metallized.

18. A transition element according to claim 1 wherein through-contactings which are connected electrically to the metallic layer on the second side of the substrate are disposed within the substrate at least one of the following locations: adjacent to the lip; in the region below the lip; in the region below the groove; along the lip; and, along the groove.

19. A microwave emitter having a transition element from a strip transmission line to a waveguide having a planar substrate which has a first side including at least one strip transmission line with at least one strip transmission line end, and a waveguide which has a circumferential lip which forms a first opening of the waveguide, wherein the waveguide is oriented in the region of the strip transmission line end with the circumferential lip on the first side of the substrate, the strip transmission line being coupled electrically to the waveguide at least one point of the lip, and a generator for producing a radiation with a wavelength λ and for supplying this radiation to the strip transmission line.

20. A method of making a transition element from a strip transmission line to a waveguide for at least one of radar applications, communications applications, applications in the microwave range, applications in the millimeter wave range, motor vehicle radar applications, height measurement applications, distance measurement applications, and level measurement applications, the method comprising providing a planar substrate which has a first side, providing the strip transmission line with at least one strip transmission line end on said first side, providing the waveguide with a circumferential lip which forms a first opening of the waveguide on said first side, orienting the waveguide in the region of the strip transmission line end with the circumferential lip on the first side of the substrate, and coupling the strip transmission line electrically to the waveguide at least one point of the lip.

21. A method for producing a microwave radiation, the method comprising providing a planar substrate which has a first side, providing a strip transmission line with at least one strip transmission line end on said first side, providing a waveguide with a circumferential lip which forms a first opening of the waveguide on said first side, orienting the waveguide in the region of the strip transmission line end with the circumferential lip on the first side of the substrate, coupling the strip transmission line electrically to the waveguide at least one point of the lip, and feeding a microwave into the strip transmission line.

22. A transition element according to claim 4 wherein the metallization on the second side of the substrate has a thickness between 10 λm and 50 λm.

23. A transition element according to claim 4 wherein the metallization on the second side of the substrate has a thickness between 500 λm and 1 mm.

24. A transition element according to claim 4 wherein the metallization on the second side of the substrate has a thickness between 17 μm and 50 μm.

25. A transition element according to claim 11 wherein the strip transmission line end is situated at least approximately in the center of the lip thickness.
